(19) United States
(12) Patent Application Publication
(10) Pub. No.: US 2011/0052797 A1
(43) Pub. Date: Mar. 3, 2011

(54) Low Temperature Plasma-Free Method for the Nitridation of Copper

(75) Inventors: Fenton Read McFeely, Yorktown Heights, NY (US); Chih-Chao Yang, Albany, NY (US); John Jacob Yurkas, Yorktown Heights, NY (US)

(73) Assignee: International Business Machines Corporation, Armonk, NY (US)

(21) Appl. No.: 12/548,269

(22) Filed: Aug. 26, 2009

(51) Int. Cl. B05D 5/12

(52) U.S. Cl. 427/96.8; 427/120

(57) ABSTRACT

Techniques for nitridation of copper (Cu) wires. In one aspect, a method for nitridation of a Cu wire is provided. The method includes the following step. The Cu wire and trimethylsilylazide (TMSAZ) in a carrier gas are contacted at a temperature, pressure and for a length of time sufficient to form a nitridized layer on one or more surfaces of the Cu wire. The Cu wire can be part of a wiring structure and can be embedded in a dielectric media. The dielectric media can comprise an ultra low-k dielectric media.

### FIELD OF THE INVENTION

The present invention relates to wiring structures and more particularly, to techniques for nitridation of copper (Cu) wires.

### BACKGROUND OF THE INVENTION

Wiring structures commonly include copper (Cu) wires embedded in a dielectric media. The exposed top surfaces of the wires are generally covered with a capping layer to protect the wire during processing. From the standpoint of electromigration resistance, it is desirable to nitridize the top surfaces of the wires before deposition of the capping layer, whether the capping layer is a metal or a dielectric. Nitridation of the wire can be achieved using plasma nitridation techniques.

However, with the advent of ultra low-k (e.g., k=2.2) porous dielectrics as the dielectric media encapsulating the Cu wires, the nitridation process poses new problems. Specifically, the use of a plasma nitridation scheme has the serious drawback of damaging the delicate porous dielectric structure. For example, highly reactive plasma species such as energetic ions can react with the dielectric, opening pore boundaries and roughening the structure in ways deleterious to further processing.

Therefore, techniques for nitridation of Cu wires that do not damage porous dielectric media would be desirable.

### SUMMARY OF THE INVENTION

The present invention provides techniques for nitridation of copper (Cu) wires. In one aspect of the invention, a method for nitridation of a Cu wire is provided. The method includes the following step. The Cu wire and trimethylsilylazide (TMSAZ) in a carrier gas are contacted at a temperature, pressure and for a length of time sufficient to form a nitridized layer on one or more surfaces of the Cu wire.

The Cu wire can be part of a wiring structure and can be embedded in a dielectric media. The dielectric media can comprise an ultra low-k dielectric media.

The method may further include the following steps. The Cu wire and a hydrogen gas can be contacted at a temperature, pressure and for a length of time sufficient to reduce any Cu oxide present on the surfaces of the Cu wire. The hydrogen gas can be removed before contacting the Cu wire and the TMSAZ in the carrier gas.

A more complete understanding of the present invention, as well as further features and advantages of the present invention, will be obtained by reference to the following detailed description and drawings.

### BRIEF DESCRIPTION OF THE DRAWINGS

FIG. 1 is a cross-sectional diagram illustrating an exemplary wiring structure according to an embodiment of the present invention;

FIG. 2 is a diagram illustrating an exemplary methodology for nitridation of a copper (Cu) wire in a wiring structure according to an embodiment of the present invention;

FIG. 3 is a graph illustrating a comparison of trimethylsilylazide (TMSAZ) and ammonia (NH₃) nitridation according to an embodiment of the present invention; and

FIG. 4 is a graph illustrating TMSAZ nitridation with varying reaction temperatures according to an embodiment of the present invention.

### DETAILED DESCRIPTION OF PREFERRED EMBODIMENTS

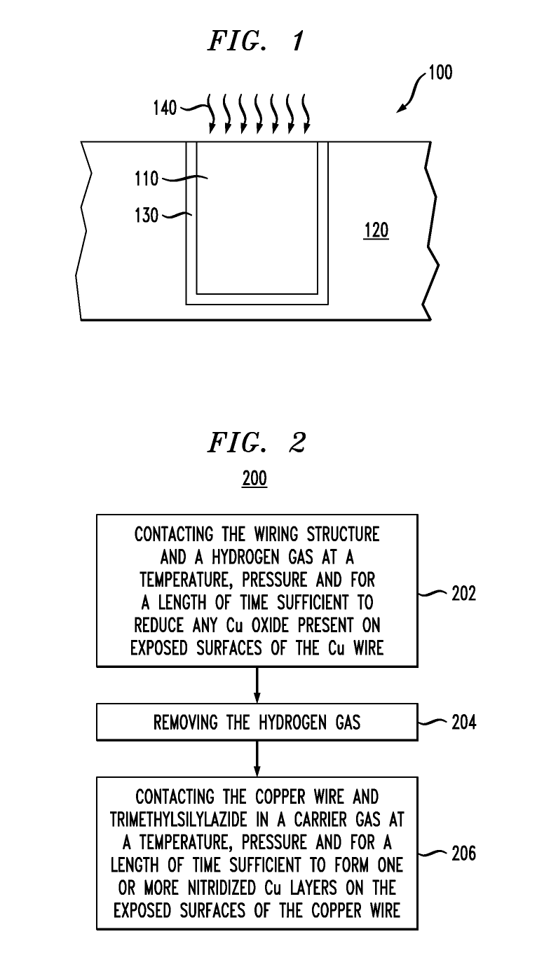

FIG. 1 is a cross-sectional diagram illustrating exemplary wiring structure 100. Wiring structure 100 comprises copper (Cu) wire 110 embedded in dielectric media 120. Suitable dielectric media include but are not limited to, silsesquioxanes, carbon doped oxides (i.e., organosilicates) that include atoms of silicon (Si), carbon (C), oxygen (O) and hydrogen (H), thermosetting polyarylene ethers, or multilayers thereof. The term “polyarylene” is used herein to denote aryl moieties or inertly substituted aryl moieties which are linked together by bonds, fused rings, or inert linking groups such as, for example, oxygen, sulfur, sulfone, sulfoxide, carbonyl and the like. According to an exemplary embodiment, dielectric media 120 comprises an ultra low-k (e.g., k=2.2) porous dielectric.

Cu wire 110 is separated from dielectric media 120 by diffusion barrier 130. Diffusion barrier 130 can comprise any suitable diffusion barrier material, including, but not limited to, tantalum nitride (TaN), or other metal nitride, oxide, sulfide, boride or phosphide.

As highlighted above, it is desirable to nitridize the exposed, top surface of Cu wire 110 (see arrows 140) before placing a capping layer (not shown) on Cu wire 110. The present teachings provide a new chemical method to nitridize Cu surfaces in the temperature range of from about 370 degrees Celsius (° C.) to about 200° C., and avoids the damage that can occur with plasma nitridation processes especially when porous dielectrics, such as ultra low-k dielectric media 120, are involved. Heretofore, purely chemical means to nitridize Cu surfaces were unsuitable, as the standard reagent, ammonia, is insufficiently reactive with Cu even at the highest temperatures a wiring structure can withstand.

FIG. 2 is a diagram illustrating exemplary methodology 200 for nitridation of a Cu wire in a wiring structure, such as wiring structure 100 described, for example, in conjunction with the description of FIG. 1, above. In step 202, the wiring structure is contacted with a hydrogen gas at a temperature, pressure and for a length of time sufficient to reduce any Cu oxide present on exposed surfaces of the Cu wire. While the instant description is directed to nitridation of a Cu wire embedded in a dielectric media, i.e., a wiring structure, the present teachings are generally applicable to the nitridation of a Cu wire in a variety of different contexts.

According to an exemplary embodiment, the steps of methodology 200 are carried out in a vacuum chamber. Accordingly, for step 202, the vacuum chamber is evacuated to a pressure of less than about 1×10⁻³ torr, e.g., to a pressure of less than about 1×10⁻⁵ torr. The wiring structure is heated to a temperature greater than about 150° C., for example, to a temperature greater than about 250° C., e.g., the wiring structure is heated to a temperature of about 370° C. The hydrogen gas, such as neat hydrogen or forming gas, is introduced into the vacuum chamber for a sufficient time and at sufficient pressure (for example, at a pressure of about 100 millitorr (mtorr) neat hydrogen gas for about 20 minutes at a temperature of 325° C.) to reduce any Cu oxide present on the Cu surface(s). The exact times and pressures required would naturally depend on the specific gas employed, but such pressure would easily be apprehended by one skilled in the art.

In step 204, the hydrogen gas is removed from the vacuum chamber. In step 206, the wiring structure is contacted with trimethylsilylazide (TMSAZ) in a carrier gas at a temperature, pressure and for a length of time sufficient to form one or more nitridized Cu layers on the exposed surfaces of the copper wire. The present teachings take advantage of the high reactivity of azo compounds as nitridation agents. Many azo compounds, such as sodium azide (NaN₃) and hydrazoic acid (HN₃), are both unstable and explosive, and thus it would be difficult, if not impossible to implement a process using such materials in a manufacturing environment. However, TMSAZ is stable and non-explosive and thus can be used as a nitridizing agent compatible with manufacturing.

The TMSAZ may be introduced into the vacuum chamber either in a static (unpumped) manner, for example, by means of a bubbler as in the example below, or flowed over the substrate with dynamic pumping. The TMSAZ is contained in a carrier gas. A suitable carrier gas includes, but is not limited to, argon gas. The argon/TMSAZ gas mixture is introduced into the vacuum chamber until the pressure in the vacuum chamber increases to from about 10⁻⁵ torr to about 10 torr, e.g., from about one torr to about 10 torr, after which, the argon/TMSAZ supply is cut off and the reaction is allowed to proceed for a length of time of from about one minute to about 10 minutes, at a temperature of from about 180° C. to about 370° C. After the reaction time period has ended, the argon/TMSAZ gas mixture is removed (i.e., pumped out) from the vacuum chamber and the wiring structure is permitted to cool down to room temperature.

The wiring structure, now with a nitridized layer on the exposed surfaces of the Cu wire, can be removed from the vacuum chamber. The nitridized layer on the Cu wire is, for example, about three angstroms thick, i.e., from about one to about three monolayers. An arbitrary number of substrates can be processed simultaneously by using methodology 200.

The present teachings are further described by reference to the following non-limiting example. A blanket film of clean (non-oxidized) Cu was prepared by evaporation onto a substrate in a vacuum chamber. A plurality of Cu substrates were prepared in this manner. The Cu substrates, which remained in the vacuum chamber at a pressure of less than 1×10⁻⁶ torr were then heated to a reaction temperature. Reaction temperatures from about 180° C. to about 370° C. were investigated.

The valve to the vacuum pump was then closed and TMSAZ was introduced into the chamber. This introduction was performed by means of a bubbler containing approximately five grams (g) of TMSAZ, through which argon carrier gas was flowed at a rate of about 50 standard cubic centimeters per minute (SCCM). The resulting argon/TMSAZ gas mixture was then directed into the evaporation/reaction chamber and the pressure in the chamber was allowed to rise to about one torr, after which the flow of argon/TMSAZ was shut off. The reaction was allowed to proceed for one minute, then the reactant gas mixture was pumped away and the substrate was cooled in a vacuum to room temperature (i.e., about 25° C.). The exact concentration of TMSAZ in the gas mixture is assumed to have been less than 10 percent (%). To make a direct comparison of this method with conventional methods, in a separate run the present protocol was modified to substitute pure ammonia (NH₃) gas for the argon/TMSAZ mixture while keeping all other parameters the same. This ensured a comparison in which the NH₃ was present in a substantially higher concentration than TMSAZ during otherwise identical reaction conditions.

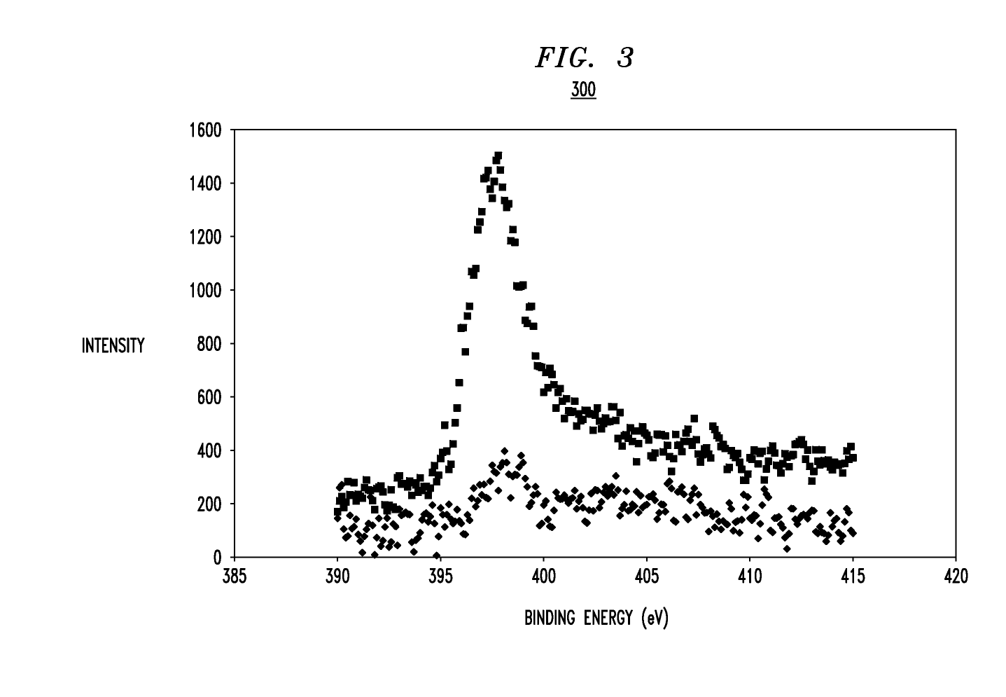

The substrates were examined by removing them from the reaction vessel and analyzing them via x-ray photoemission spectroscopy (xps). FIG. 3 is a graph 300 illustrating a comparison of the xps spectra of the nitrogen 1s core level for a Cu substrate treated as described above with the TMSAZ mixture (represented with squares) and with pure NH₃ (represented with diamonds) at 370° C. In graph 300, binding energy (measured in electron Volts (eV)) is plotted on the x-axis and intensity is plotted on the y-axis.

The sample treated with TMSAZ, the upper curve, shows a distinct peak confirming the presence of a nitridized Cu surface. An analysis of the intensity of this peak indicates that the thickness of the nitridized layer is on the order of a few angstroms, i.e., from about one to about three monolayers. In contrast, the substrate treated with pure NH₃ shows, as expected, at most a trace amount of nitrogen. Thus, this experiment conclusively demonstrates the superiority of the nitridation method proposed in the present invention over conventional methods.

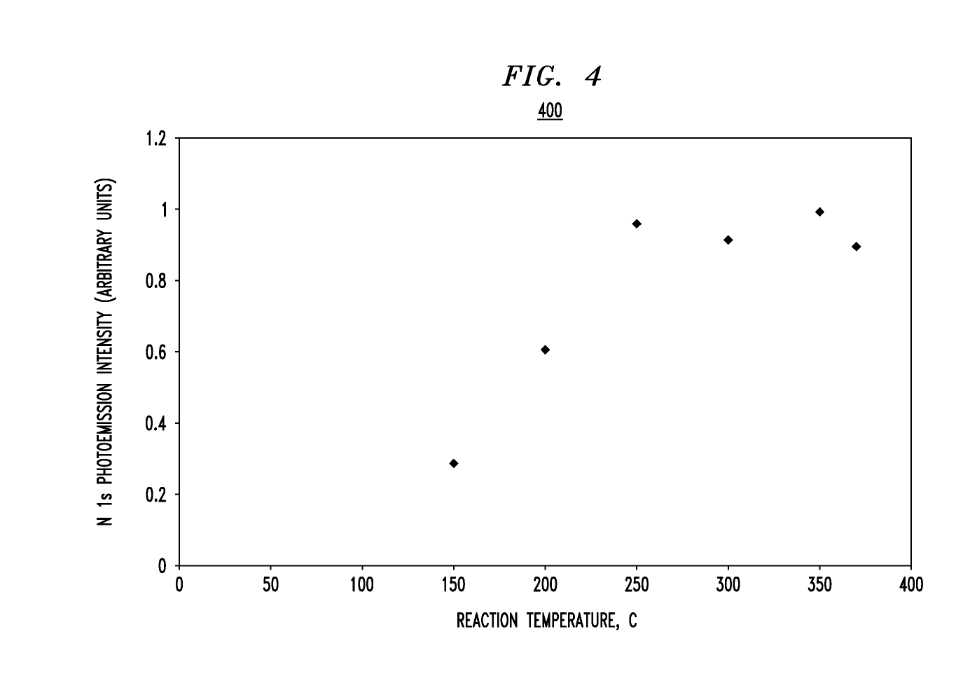

FIG. 4 is a graph 400 illustrating the N1s photoemission intensities of substrates treated as in the example above but with varying reaction temperatures. In graph 400, reaction temperature (measured in ° C.) is plotted on the x-axis and N1s photoemission intensity (measured in arbitrary units) is plotted on the y-axis. As can be seen from graph 400, above about 250° C. no increase in nitridation is observed with increasing reaction temperature. This result indicates that 325° C. can be considered an effective processing temperature for present techniques.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for nitridation of a copper wire, comprising the step of:
contacting the copper wire and trimethylsilylazide in a carrier gas at a temperature, pressure and for a length of time sufficient to form a nitridized layer on one or more surfaces of the copper wire.

2. The method of claim 1, wherein the carrier gas comprises argon gas.

3. The method of claim 1, wherein the copper wire is part of a wiring structure and is embedded in a dielectric media.

4. The method of claim 3, wherein the dielectric media comprises an ultra low-k dielectric media.

5. The method of claim 1, wherein the step of contacting the copper wire and the trimethylsilylazide in the carrier gas is performed in a vacuum chamber.

6. The method of claim 1, wherein the copper wire and the trimethylsilylazide in the carrier gas are contacted at a temperature of from about 180° C. to about 370° C.

7. The method of claim 1, wherein the copper wire and the trimethylsilylazide in the carrier gas are contacted at a pressure of from about 10⁻⁵ torr to about 10 torr.

8. The method of claim 1, wherein the copper wire and the trimethylsilylazide in the carrier gas are contacted at for a length of time of from about one minute to about 10 minutes.

9. The method of claim 1, wherein the nitridized layer is about three angstroms thick.

10. The method of claim 1, further comprising the steps of:
contacting the copper wire and a hydrogen gas at a temperature, pressure and for a length of time sufficient to reduce any copper oxide present on the surfaces of the copper wire; and
removing the hydrogen gas before contacting the copper wire and the trimethylsilylazide in the carrier gas.

11. The method of claim 10, wherein the step of contacting the copper wire and the hydrogen gas is performed in a vacuum chamber.

12. The method of claim 10, wherein the copper wire and the hydrogen gas are contacted at a temperature of greater than about 150° C.

13. The method of claim 10, wherein the copper wire and the hydrogen gas are contacted at a pressure of about 100 millitorr.

14. The method of claim 10, wherein the copper wire and the hydrogen gas are contacted at for a length of time of about 20 minutes.
